(19) United States
(12) Patent Application Publication
(10) Pub. No.: US 2008/0303317 A1
(43) Pub. Date: Dec. 11, 2008

(54) Driving Device of a Movable Vehicle Component

(75) Inventor: Fritz Wegener, Gilching (DE)

Correspondence Address: DICKINSON WRIGHT PLLC, 1901 L. STREET NW, SUITE 800, WASHINGTON, DC, 20036, US

(73) Assignee: WEBASTO AG, Stockdorf (DE)

(21) Appl. No.: 12/097,296

(22) PCT Filed: Dec. 14, 2006
(86) PCT No.: PCT/DE2006/002231

§ 371 Date: Jul. 22, 2008

(30) Foreign Application Priority Data
Dec. 14, 2005 (DE) 10 2005 060 206.1

(51) Int. Cl. B60J 7/12; B60J 7/20; B60J 7/185

(52) U.S. Cl. 296/219

(57) ABSTRACT

The invention relates to a driving device of a movable vehicle component, especially a soft top compartment cover of a convertible. Said driving device is coupled to a bearing mechanism of the movable component to perform a main function while being joined to an additional functional unit to perform an additional function, said additional functional unit being actuated by the driving device. In order to improve the movement behavior, the driving device (19) comprises a pivotable bearing (23) that is guided in a longitudinally movable manner at the vehicle body end, the activated driving device (19) performs the additional function in a starting position by means of a longitudinal movement of the bearing (23) thereof, and the driving device (19) pivots about the bearing (23) thereof into a swiveled position when the bearing mechanism (7, 14) of the component (6) is displaced, the driving device (19) being prevented from longitudinally moving the beating (23) thereof counter to the first moving direction of the additional function with the aid of a stop in said swiveled position.

The invention relates to a drive apparatus for a movable component of a vehicle, in particular for a roof compartment cover, of a convertible, which on the one hand is coupled to a bearing device for the movable component in order to carry out a main function and on the other hand is connected to an additional functional unit, which can be operated by the drive apparatus in order to carry out an additional function.

DE 103 13 496 A1 discloses a roof for a convertible, which can be moved by means of a drive device between an open position and a closed position. The drive device is connected on the one hand to the bearing device for the roof and on the other hand is supported via a bolt, which is mounted such that it can pivot, on the bodywork side, which bolt keeps the stowed roof locked. When the stowed roof is being raised, the drive device first of all operates the bolt, in order to unlock the roof, on the first part of its movement.

The invention is based on the object of improving the functionality and simplifying the operation of a drive apparatus as mentioned initially.

According to the invention, the object is achieved for the drive apparatus mentioned initially in that on the bodywork side, the drive apparatus has a bearing which is guided such that it can move longitudinally and can pivot, in that, in an initial position, the activated drive apparatus carries out the additional function by longitudinal movement of its bearing, and in that, during movement of the bearing device of the component about its bearing, the drive apparatus pivots to a pivoted position in which a stop prevents longitudinal movement of its bearing in the opposite direction to the first movement direction of the additional function. The stop prevents any reaction force of the component being able to undesirably move the drive device, which would also carry out the additional function at an undesirable time. A component reaction force can occur when the component is being pivoted to the open position. If the component is a roof compartment cover or the like, this could move to a beyond dead center position with respect to its bearing axis when in its open position, if the vehicle is parked on a gradient with the rear end pointing downward.

Advantageous refinements of the invention are specified in the dependent claims.

The drive apparatus preferably contains a first element which is connected to the bearing, and a second element, which is coupled to the component, which elements can be moved with respect to one another by operation of the drive apparatus, in particular with the drive apparatus containing a piston-cylinder unit, and with the first element being a cylinder housing and with the second element being a piston rod. In principle, the electrical hydraulic or pneumatic drives and, in particular, linear drives are suitable for use as a drive apparatus and, in addition to piston-cylinder units, may also have actuating motors with spindles or the like.

One preferred embodiment provides for the first element or the cylinder housing to rest on the stop in the pivoted position. In this case, the stop may be in the form of a part fixed to the bodywork or, in an alternative embodiment, it is formed on a part which is mounted so that it can pivot on the bodywork side, and pivots with the drive apparatus. As a part which is fixed to the bodywork, the stop is, for example, a web or a slotted link, which is fitted to a bearing plate (which is fixed to the bodywork) of the drive device and in particular has a curved action surface in the form of a web, whose center of curvature coincides with the associated pivoting axis of the first element or of the cylinder housing. Instead of an element in the form of a web or line, an element in the form of a point can also be provided on the bearing plate, in order to act with a linear part on the first element or on the cylinder housing.

If the stop is formed on a part which is mounted so that it can pivot on the bodywork side, and the stop pivots with the drive apparatus, then, in contrast to the stop that is fixed to the bodywork, this reduces or prevents any relative movement between the stop and the pivoting part of the drive apparatus, and therefore also any friction resistance. By way of example, the part which is mounted such that it can pivot is a catch lever whose pivoting axis on the bodywork side is arranged close to the pivoting axis of the pivoting part of the drive apparatus, or coincides with it. A projecting catch or tab forms the stop for the corresponding mating piece or action part of the drive apparatus. The drive apparatus or its first element expediently contains a pin or, in general, at least one projecting part which rests on the at least one stop. Two mutually opposite coaxial pins preferably project on both sides of the drive apparatus or of the cylinder housing and engage with two associated stops on a catch lever.

The mounting device with the roof compartment cover, which may also be in the form of a rear-area flap or a luggage-compartment cover, is intended for convertibles with a convertible hard-top or soft-top roof, but can also be used for other vehicles. In principle, the drive apparatus is suitable for driving various vehicle flaps as well as various additional functions, such as locking or unlocking.

A drive apparatus according to the invention will be explained in more detail in the following text using exemplary embodiments and with reference to the drawing, in which:

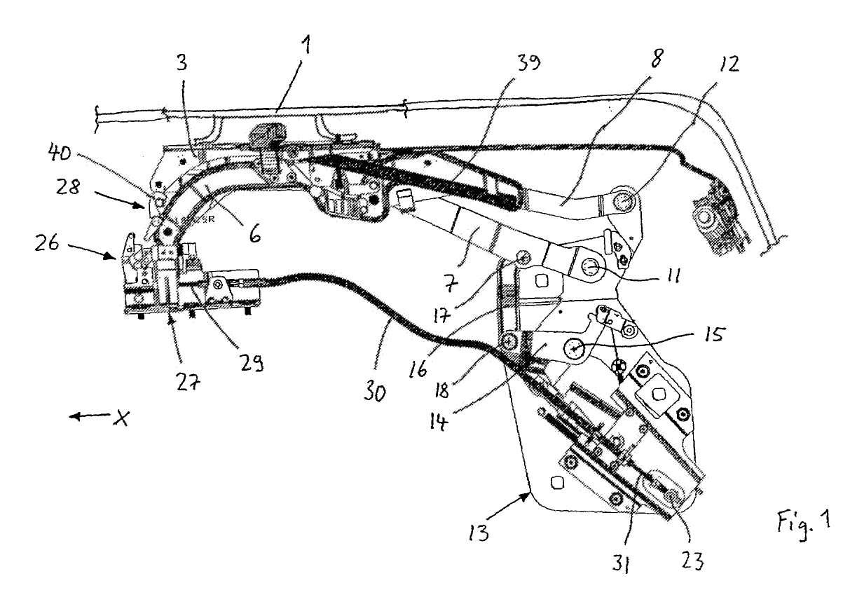

FIG. 1 shows a side view of a mounting device on the right-hand side of a roof compartment cover for a convertible, which is arranged in the closed position, as well as a locking device for the roof compartment cover, and a drive apparatus for pivoting the mounting device and the roof compartment cover;

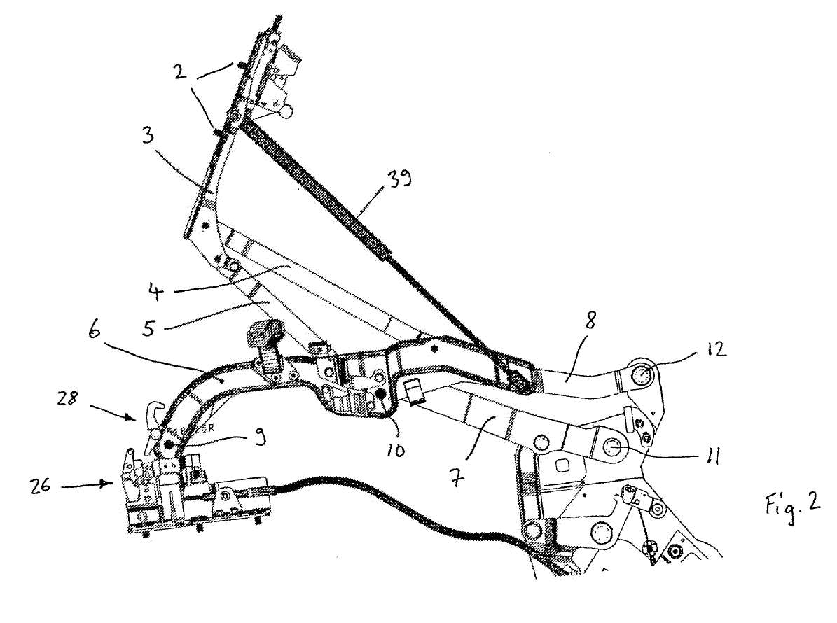

FIG. 2 shows a view corresponding to FIG. 1 of the mounting device with the roof compartment cover pivoted up;

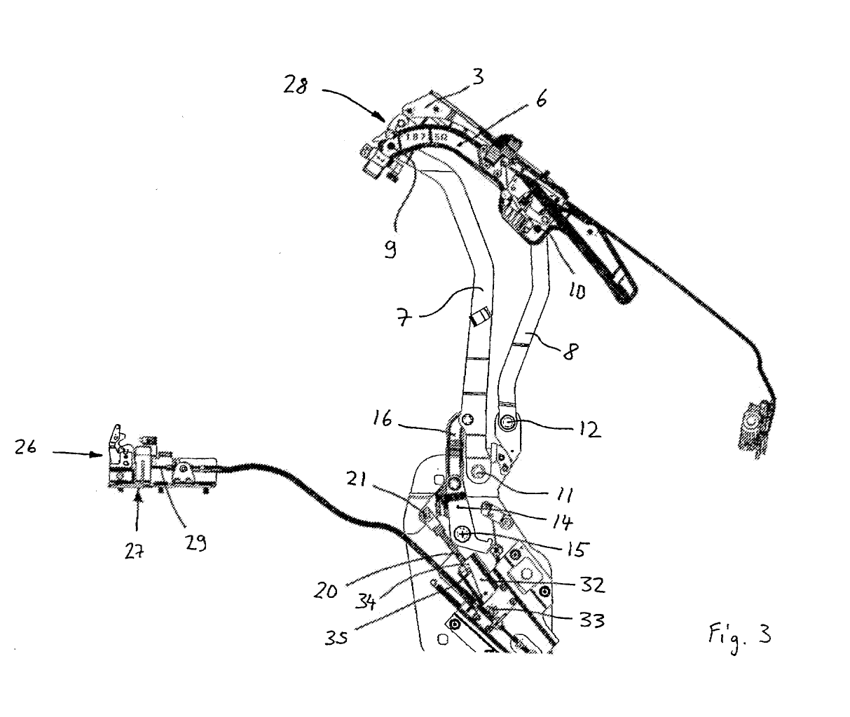

FIG. 3 shows a view corresponding to FIG. 1 of the unit which is pivoted up by the drive apparatus and comprises the mounting device and the roof compartment cover;

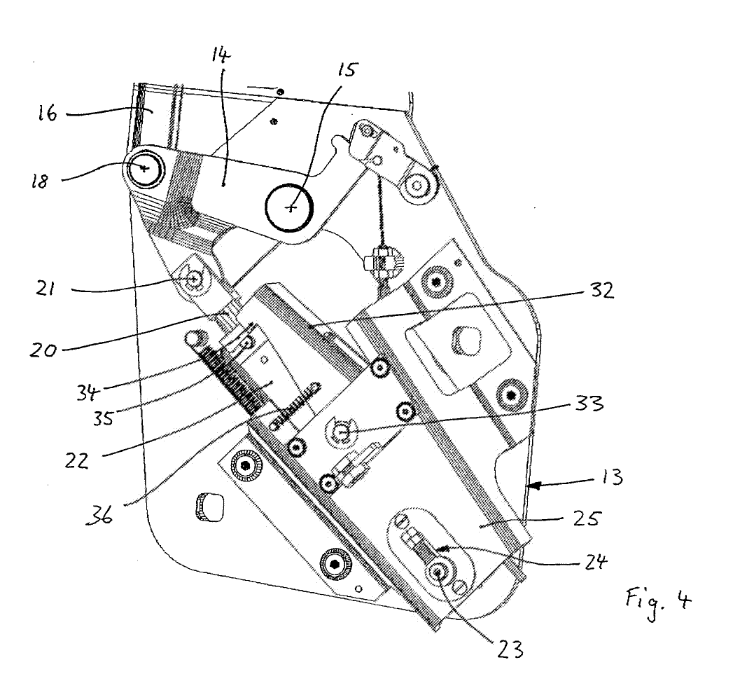

FIG. 4 shows a side view, in the form of enlarged illustration, of the drive apparatus in a position corresponding to that of FIG. 1;

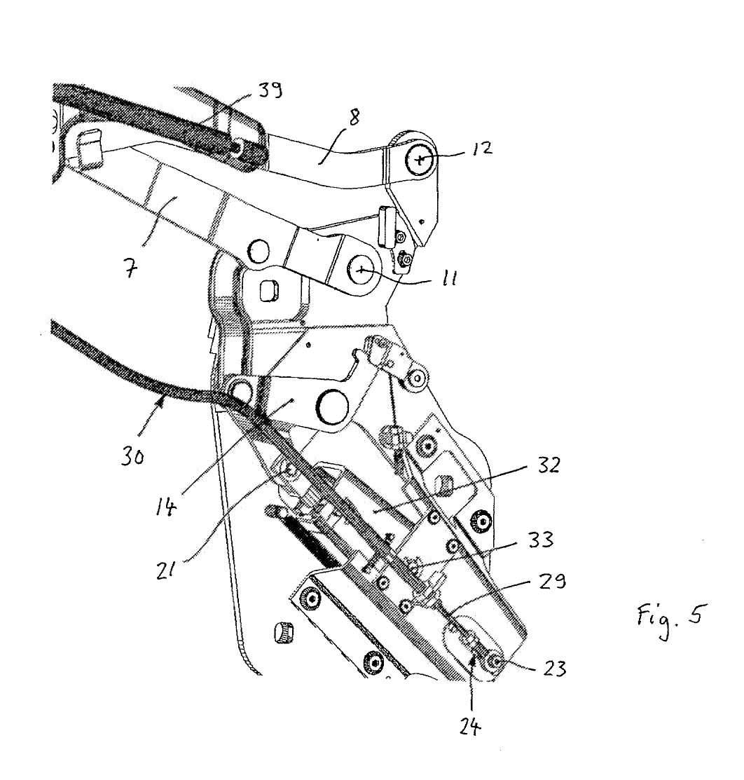

FIG. 5 shows a perspective view of the drive apparatus as shown in FIG. 4;

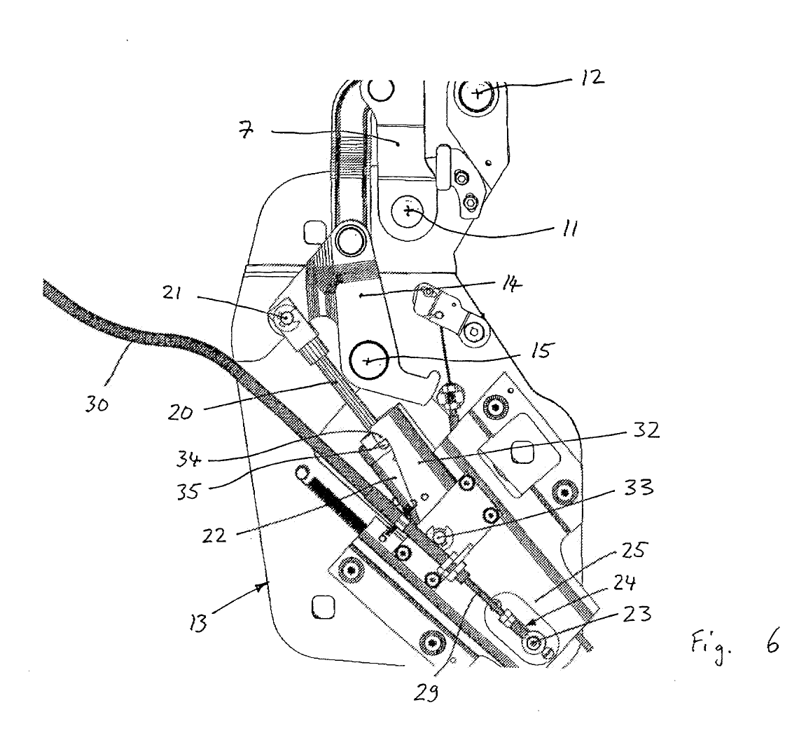

FIG. 6 shows a side view corresponding to FIG. 4 of the drive apparatus moved to a limit position with the mounting device pivoted up;

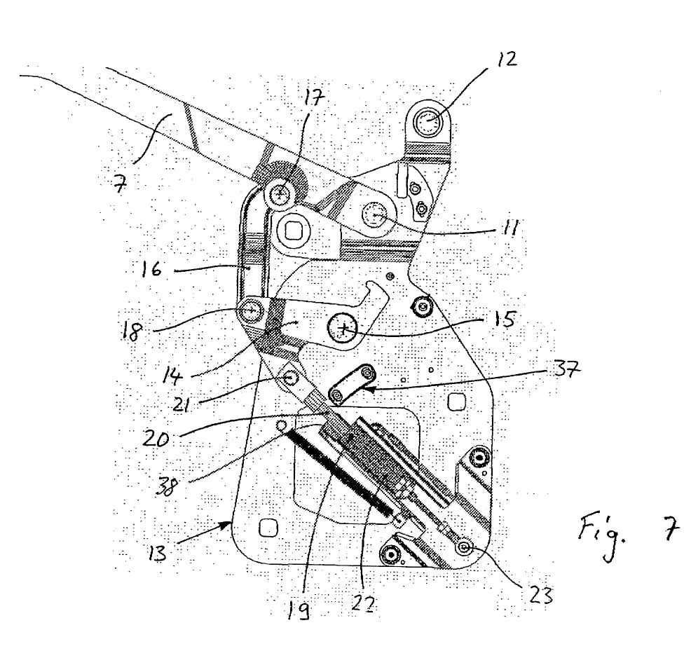

FIG. 7 shows a side view corresponding to FIG. 6 of a modified exemplary embodiment with a stop fixed to the bodywork for the drive apparatus; and

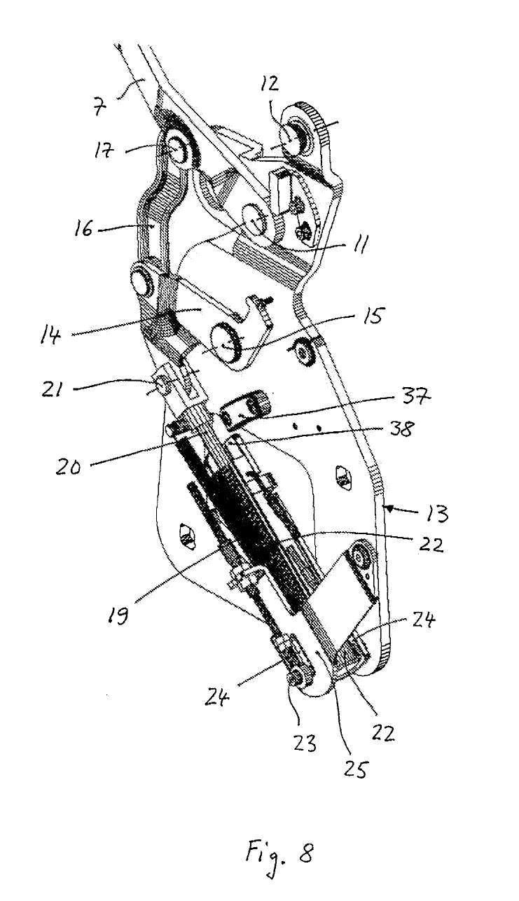

FIG. 8 shows a perspective view of the modified exemplary embodiment shown in FIG. 7.

A convertible has a roof compartment cover 1 (the roof compartment cover 1 is illustrated in the form of a detail and schematically only in FIG. 1), which is intended to cover a roof stowage area at the rear and whose front edge (the arrow annotated x in FIG. 1 is pointed forward in the vehicle longitudinal direction) is raised in order to release an aperture opening for the folding roof, which can be moved between its closed position and its stowed position and may be a hard-top roof or else a soft-top roof. The roof compartment cover 1 is expediently also used as a luggage-compartment cover by its rear edge being pivoted up (FIG. 2) relative to the bodywork from its closed position (FIG. 1), thus releasing a loading opening for the luggage compartment. DE 44 45 944 C1 discloses a comparable roof compartment cover, which is supported via an auxiliary frame on the bodywork and, according to the exemplary embodiment, is mounted at the rear of the vehicle such that it can pivot about a pivoting axis which is fixed to the bodywork.

The roof compartment cover 1 is attached to a bracket 3 on both sides by means of a respective holder which, for example, contains a plurality of threaded bolts 2, and the bracket 3 is in turn mounted on a mounting device via a four-section joint, which is formed by two guides 4 and 5, such that it can pivot, which mounting device is formed, for example, by a frame 6 which supports the bracket 3 and the four-section joint 4, 5. The description is based on the right-hand side of the mounting device, which is essentially symmetrical with respect to the vehicle longitudinal axis, of the roof compartment cover, with the respective drive device and locking apparatus.

The left-hand side and the right-hand side frame 6 can be firmly connected to one another for example by means of a lateral rod or the like, in order to make the mounting device more robust.

The mounting device or the frame 6 of the roof compartment cover 1 is mounted on both sides of the bodywork such that it can pivot, in each case by means of a main guide 7 and an auxiliary guide 8, which form a four-section joint with the joints 9 and 10 on the frame 6 and the joints 11 and 12 on a bearing plate 13 that is fixed to the bodywork.

A pivoting guide 14 is mounted in a joint on the bearing plate 13 such that it can pivot about a pivoting axis 15. A connecting rod 16 connects the main guide 7 to the pivoting guide 14 in the joints 17 and 18. A drive unit, which is arranged on the main guide 7, and is in the form of a hydraulic piston-cylinder unit 19, contains a piston rod 20 which is articulated at an articulation point 21 on the pivoting guide 14. The piston-cylinder unit 19 is on the other hand mounted on two elongated hole guides 24 via its cylinder housing 22 and a bearing pin 23 (which is fitted to it at the end) such that it can move linearly, and these elongated-hole guides 24 are arranged in the bearing plate 13 or a cover plate 25 which is fitted parallel to it.

A bolt device for the roof compartment cover 1 contains a first lock unit 26 (see FIGS. 1 to 3) for detachably fixing the front end, which extends downward, of the frame 6 on a bearing unit 27 which is fixed to the bodywork, and a second lock unit 28 for detachably fixing the bracket 3 of the roof compartment cover 1 at the front end of the frame 6. The first lock unit 26 has a bolt hook, which is mounted such that it can pivot on the bearing unit 27 which is fixed to the bodywork, for detachably fixing the frame 6, which bolt hook is connected directly or indirectly to a cable 29 of a Bowden cable 30, whose other end 31 is fitted to the bearing pin 23 of the piston-cylinder unit 19.

A catch lever 32 (see FIG. 4) is mounted on the bearing plate 13 and the cover plate 25 such that it can pivot about a pivoting axis 33. The catch lever 32, which surrounds approximately half one side of the cylinder housing 22, contains a stop 34 in the form of a hook or catch on each of the two sides of the cylinder housing 22, on each of which stops 34 a pin 35 which projects on the cylinder housing 22 can be supported. A spring 36 holds the catch lever 32 prestressed in its initial position as shown in FIG. 4 with respect to the piston-cylinder unit 19, in which initial position the pin 35 together with the cylinder housing 22 can move past the stop 34 in the longitudinal direction of the cylinder housing 22.

When the roof is intended to be open and stowed in the roof compartment, the roof compartment cover 1 must first of all be raised at its front edge by means of the frame 6, thus releasing the path for the stowage movement of the roof (in the same way as to move out during closure of the roof).

In the position illustrated in FIG. 1, the frame 6 is supported in the bearing unit 27 on the bodywork, and the first lock unit 26 has already been unlocked, so that the frame 6 can be pivoted by means of the drive device or the piston-cylinder unit 19 in order to carry out the main function of the drive device. The process of unlocking the first lock unit 26, which represents an additional function of the drive device, is carried out in that, from its initial position in which the cylinder housing 22 is located at an upper limit position, and the bearing pin 23 likewise assumes an upper position in the elongated-hole guide 24 (not illustrated) the piston-cylinder unit 19 carries out an initial expansion movement, by pressure being applied to it, during which the cylinder housing 22 and therefore the bearing pin 23 are first of all moved on the elongated-hole guide 24 from the upper position to the lower stop position (movement to the position shown in FIGS. 1 and 4). During this process, the pin 35 on the cylinder housing 22 reaches a position at the side, in front of the stop 34.

During this movement of the cylinder housing 22, the first lock unit 26 is unlocked by means of the cable 29, which is moved at the same time, of the Bowden cable 30. The initial expansion movement of the piston-cylinder unit 19 necessarily takes place in this manner by movement of the cylinder housing 22 with the piston rod 20 stationary, since the weight of the roof compartment cover 1 and of the frame 6 acts via the connecting rod 16 as an opposing force on the pivoting guide 14, and the piston-cylinder unit 19 therefore first of all carries out the additional function, because of the reduced resistance and force required.

This first movement is therefore used to carry out the additional function which, in the present exemplary embodiment, represents the unlocking of the first lock unit 26 and can be carried out with considerably less force being required than the main function, the pivoting or opening of the frame 6 with the roof compartment cover 1 mounted on it.

Once the cylinder housing 22 with the bearing pin 23 has reached the lower limit position (FIGS. 1 and 4), the piston rod 20 is extended and further pressure is applied to the piston-cylinder unit 19, and pivots the pivoting guide 14 and, via the connecting rod 16, the main guide 7 as well, thus raising the frame 6 (movement from FIG. 1 to FIG. 3). Since the articulation point 21 of the piston rod 20 is guided by the pivoting guide 14 on a circular path around the pivoting axis 15, the piston-cylinder unit 19 also pivots about the bearing pin 23 and, in its maximum extended position (see FIGS. 3 and 7), assumes a pivoted position in which the pin 35 has been pivoted behind the stop 34 on the catch lever 32, has pivoted the catch lever 32 in the same way about its pivoting axis 33 (FIG. 6).

When, as shown in FIG. 3, the frame 6, which has been pivoted up with the roof compartment cover 1, produces a weight force, which results in a tension mode on the piston-cylinder unit 19, via the pivoting guide 14 in a corresponding position relative to the joint 11 (beyond dead center position), the pin 35 which is held by the stop 34 prevents the cylinder housing 22 and therefore the bearing pin 23 being able to carry out a backward movement along the elongated-hole guide 24. In consequence, on the one hand, the frame 6 remains stable in its respective open position and, on the other hand, the cable 29 of the Bowden cable 30 does not move, and the position of the first lock unit 26 is therefore not changed.

When the frame 6 and, with it, the roof compartment cover 1 are raised, the roof can be moved in a known manner into the roof compartment or roof stowage area, and can also be moved out again in order to close the roof.

The closing of the roof compartment cover 1 or of the frame 6 (movement from FIG. 3 to FIG. 1) is carried out with the opposite movement procedure by retraction of the piston rod 20 of the piston-cylinder unit 19, with the stop 34 of the catch lever 32 initially keeping the pin 35 locked, and with the guiding pin 23 and therefore the cylinder housing 22 of the piston-cylinder unit 19 remaining in the lower position, thus ensuring a defined movement sequence as well during closure of the roof and of the roof compartment cover 1 and the frame 6.

As the piston rod 20 moves inward, the piston-cylinder unit 19 is pivoted back to the initial position as shown in FIG. 4. In this case, the catch lever 32 likewise pivots above its pivoting axis 33 back against a stop which limits the pivoting angle, so that the pin 35 is pivoted out to the side from the stop 34 of the catch lever 32. Finally, the frame 6 once again rests on the bearing unit 27.

The final movement path of the piston rod 20 as it is moved in is carried out by the cylinder housing 22 of the piston-cylinder unit 19 relative to the stationary piston rod 20. During this process, the bearing pin 23 moves in the elongated-hole guide 24 from the lower limit position to the upper limit position, while the pin 35 on the cylinder housing 22 can move laterally, past the stop 34 on the catch lever 32, in the direction of the articulation point 21. the bearing pin 23 moves the cable 29 with a pressure load against the first lock unit 26 and operates this in order to lock the frame 6 on the bearing unit 27. The additional function is therefore also carried out after the main function.

Since the catch lever 32 pivots with the pin 35 which is resting on the stop 34, this avoids any relative movement between the pin 35 and the stop 34, which would result in comparatively high friction resistance.

In contrast, there is only little friction in the pivoting bearing 33.

In the modified embodiment illustrated in FIGS. 7 and 8, a stop 37 is provided, is fitted firmly to the bearing plate 13 and, for example, is in the form of a curved strip whose center of curvature coincides with the pivoting axis of the cylinder housing 22 and the bearing pin 23. A support plate 38 is fitted to the cylinder housing 22, is pivoted in front of the stop 37 during pivoting of the cylinder housing 22, and rests on it for support purposes. When the piston-cylinder unit 19 is moved back (FIGS. 7 and 8) to its initial position from its pivoted-out open position (corresponding to FIG. 6), and in the process the support plate 38 rests on the stop 37 as a result of the piston-cylinder unit 19 being correspondingly loaded by the roof compartment cover 1, the support plate 38 moves along the stop 37, with a sliding contact.

In the position shown in FIGS. 7 and 8, the support plate 38 can move past the stop 37 at the side when the cylinder housing 22 is moved upwards again when it carries out the additional function, and the bearing pin 23, which moves with it, closes the lock unit 26 again via the cable 30.

The Bowden cable 30 can be matched very flexibly to the physical characteristics in the rear area of the bodywork. However, other means such as a linkage can also be used to transmit the operating movement.

The roof compartment cover 1 can be supported with respect to the frame 6 by means of a respective gas compression spring 39 thus relieving the load from its weight during manual pivoting in its function as a luggage compartment cover (FIG. 2). Before the roof compartment cover 1 is pivoted, the second lock unit 28 is operated such that the bracket 3 is no longer locked to the frame 6. The operation can be carried out with the operation of the first lock unit 26, via this, in that a bolt hook 40 of the second lock unit 28 is unlocked during locking of the first lock unit 26.

List of reference symbols

| | |
|---|---|
| 1 | Roof compartment cover |
| 2 | Threaded bolt |
| 3 | Bracket |
| 4 | Guide |
| 5 | Guide |
| 6 | Frame |
| 7 | Main guide |
| 8 | Auxiliary guide |
| 9 | Joint |
| 10 | Joint |
| 11 | Joint |
| 12 | Joint |
| 13 | Bearing plate |
| 14 | Pivoting guide |
| 15 | Pivoting axis |
| 16 | Connecting rod |
| 17 | Joint |
| 18 | Joint |
| 19 | Piston-cylinder unit |
| 20 | Piston rod |
| 21 | Articulation point |
| 22 | Cylinder housing |
| 23 | Bearing pin |
| 24 | Elongated hole guide |
| 25 | Cover plate |
| 26 | First lock unit |
| 27 | Bearing unit |
| 28 | Second lock unit |
| 29 | Cable |
| 30 | Bowden cable |
| 31 | End |
| 32 | Catch lever |
| 33 | Pivoting axis |
| 34 | Stop |
| 35 | Pin |
| 36 | Spring |
| 37 | Stop |
| 38 | Support plate |
| 39 | Gas compression spring |
| 40 | Bolt hook |

1. A drive apparatus for a movable component of a vehicle, in particular for a roof compartment cover, of a convertible, which on the one hand is coupled to a bearing device for the movable component in order to carry out a main function and on the other hand is connected to an additional functional unit, which can be operated by the drive apparatus in order to carry out an additional function,
characterized in that, on the bodywork side, the drive apparatus has a bearing which is guided such that it can move longitudinally and can pivot,
in that, in an initial position, the activated drive apparatus carries out the additional function by longitudinal movement of its bearing, and
in that, during movement of the bearing device of the component about its bearing, the drive apparatus pivots to a pivoted position in which a stop prevents longitudinal movement of its bearing in the opposite direction to the first movement direction of the additional function.

2. The drive apparatus of claim 1, characterized in that the drive apparatus has a first element, which is connected to the bearing, and a second element, which is coupled to the component, which elements and can be moved with respect to one another by operation of the drive apparatus, in particular with the drive apparatus containing a piston-cylinder unit, and with the first element being a cylinder housing and with the second element being a piston rod.

3. The drive apparatus of claim 2, characterized in that the first element or the cylinder housing rests on the stop in the pivoted position.

4. The drive apparatus of claim 1, characterized in that the stop is a part which is fixed to the bodywork.

5. The drive apparatus of claim 1, characterized in that the stop is formed on a part which is mounted such that it can pivot on the bodywork side, and the stop pivots with the drive apparatus.

6. The drive apparatus of claim 1, characterized in that a pin of the first element rests on the stop.

7. The drive apparatus of claim 1, characterized in that the drive apparatus or the piston rod is connected to a pivoting lever which is coupled to the bearing device of the movable component.

8. The drive apparatus of claim 1, characterized in that the additional functional unit is a lock unit for fixing the component.

9. The drive apparatus of claim 1, characterized in that a roof compartment cover is mounted on the component such that it can move.
